(19) United States
(12) Patent Application Publication
(10) Pub. No.: US 2015/0242980 A1
(43) Pub. Date: Aug. 27, 2015

(54) Processes to Enable Individuals to Opt Out (or be Opted Out) of Various Facial Recognition and other Schemes and Enable Businesses and other Entities to Comply with Such Decisions

(71) Applicants: Donald Henry, Menlo Park, CA (US); Charles Marshall, Atherton, CA (US)

(72) Inventors: Donald Henry, Menlo Park, CA (US); Charles Marshall, Atherton, CA (US)

(73) Assignee: DONOTGEOTRACK, INC., Atherton, CA (US)

(21) Appl. No.: 14/628,216

(22) Filed: Feb. 21, 2015

Related U.S. Application Data
(60) Provisional application No. 61/942,678, filed on Feb. 21, 2014.

(51) Int. Cl. G06Q 50/26; G06K 9/00

(52) U.S. Cl. CPC G06Q 50/265; G06K 9/00288; G06K 9/00228

(57) ABSTRACT

Falling costs of imaging technologies, processing, data storage, and networking have led to an explosion in the use of facial recognition technologies previously used almost exclusively by governments at border checkpoints and around other high value and sensitive locations. Increasingly, private companies are using these technologies, usually paired with other technologies and data for commercial purposes. This widespread and growing use of facial recognition has profound implications for personal privacy. While government use of facial recognition technology is generally unrestricted in public places and commercial use is largely unregulated, more stringent controls are likely to be imposed upon uses of facial recognition. The disclosure provides a multifaceted method of administering a system whereby individuals can request or demand (depending on the legal framework) to opt out of facial recognition collection, processing, correlation, storage, and dissemination.

### CROSS REFERENCE TO RELATED APPLICATIONS

The present application relates to and claims priority of U.S. provisional patent application (“Copending Provisional Application”), Ser. No. 61/948,678, entitled “PROCESSES TO ENABLE INDIVIDUALS TO OPT OUT (OR BE OPTED OUT) OF VARIOUS FACIAL RECOGNITION AND OTHER SCHEMES AND ENABLE BUSINESSES AND OTHER ENTITIES TO COMPLY WITH SUCH DECISIONS AND A PROCESS FOR PROTECTING PRIVACY THROUGH MOBILE DEVICE SIGNATURE-HOPPING,” filed on Feb. 21, 2014. The disclosure of the Copending Provisional Application is hereby incorporated by reference in its entirety.

### BACKGROUND OF THE INVENTION

1. Field of Invention

The present application relates to administering a process whereby individuals may demand or request to opt out of facial recognition and other data collection. The process intervenes either at the time of collection to preclude collection of a facial image, through biometric information to identify a person as opted out after collection, through linkages made to other data after collection whereby a person is identified and linked to the opted out status, or by links to opted-out status which will preclude a third party from identifying a person in a picture or video (i.e., tagging on Facebook®).

2. Discussion of Related Art

The advent of relatively inexpensive imaging technologies paired with falling costs of processing, storage, and networking have made the exploitation of facial images widespread and increasingly ubiquitous. The privacy implications of such practices are numerous because personal data is collected unconsented and passively from people who have made no decision to use any particular technology. There is no technological solution to opting out of this intrusive data collection save for wearing complete head cover. As a person's face is the primary element of a person's external identity, such a practice would require a person to sacrifice his or her identity to preserve his or her privacy.

Facial recognition, until recently largely limited to government collection at border crossings and other high profile locations, is becoming widespread, allowing at least a crude geo-tracking of a person's movements. When combined with other data such as geo-tracking through other means such as from mobile device movements, credit card and affinity card usage, and license plate scanning, a person's identity can be established and movements and activities can be tracked nearly continuously. This is the infrastructure of a surveillance state. This is the infrastructure that allows commercial firms to intrusively target individuals with tightly tailored advertisements based on sometimes wrong assumptions. The privacy concern about this technology is not only the image which is taken, processed, stored, and disseminated but the linking of that image to a particular place and time and to those also in the image, be they companions or mere passersby.

While commercial use of facial recognition technologies is largely unregulated (expect perhaps for young children under the Children's Online Privacy Protection Act of 1998 (COPPA)),¹ and government use is largely unrestricted in public areas, greater regulation seems likely in the future and many companies may wish to the accede to the preferences of individuals to opt out of such activities. ¹ 5 USC 6501-6506

### SUMMARY OF THE INVENTION

This application discloses a number of related processes whereby individuals using mobile devices may enhance their privacy. Some processes entail enrollment in an opt-out registry requesting (or demanding when supported by legal rights) to be excluded from the collection, processing, storage, dissemination, sale, trade, or transfer of facial recognition data (or other undesired or unconsented collection activities). Other methods involve the use of beacons to alert collection devices that a person carrying a mobile device is opted out of certain collection activities or an area or location is similarly off limits. Still other methods involve the opting-out of geographical areas from certain collection (bars or restaurants from facial recognition; movie theaters from video recording). A combination of some of the above methods uses the values of detectable, identifying signatures of a mobile device as a beacon-like alert to collection sensors: certain values such as specific ranges would denote that the user of a device is opted-out of specific collection activities.

The first method involves mobile device users registering their device with an opt-out registry. Parents or guardians could similarly enroll their children or wards. The registry could include both personal identifying information, information about personal mobile devices, and biometric data to allow identification of opted-out individuals, although it could be built without the biometric data. Removing an individual from the network of facial recognition data collection and exchange is not as straight forward as removing an individual from other data collection. Consequently, several processes are described herein which block the collection, processing, storage, disseminate, sale, trade, or transfer of such information. This first process has a networked sensor paired with an imaging device. The sensor can detect identifying signatures any mobile device carried by the opted out user. If such a device is detected near the imaging system, the sensor queries the opt-out registry to determine if it belongs to an opted-out person. No imagery would be taken (or if taken, restricted in use) if a device belonging to an opted out person is nearby.

The second method is a more elaborate version of the first process whereby the networked sensor paired with the imagery device is sophisticated enough to determine when a person carrying a mobile device might be within the field of view of the imaging device. If so, the sensor queries the opt-out registry to determine whether the person is opted-out and if so, no imagery is taken (or if taken, restricted in its use).

The third method uses a mobile beacon which can be detected by a sensor paired with an imaging device (or other data collection system). The beacon signal denotes that the person carrying it is opted-out of certain types of collection. The sensor would be able to determine this without having to query an opt-out registry based on the parameters of the beacon signal. A beacon signal might be created by a mobile device or through a separate device entirely. This beacon method could be used either with a proximity rule (as in the first method) or a field of view rule (as in the second method).

The fourth method applies to networked devices with locational capabilities such as Google Glass® that collect images and or other data. The opt-out registry in this method includes not only people and the devices they carry but also geographical locations. The networked device would query the opt-out registry to determine if certain types of collection are disallowed in certain places. Imaging or other collection would only be allowed in areas not opted-out.

The fifth method also relates to mobile devices with imaging or other data collection capabilities. In this method a geographically fixed or stationary but moveable beacon alerts nearby mobile collection devices that certain types of collection are not allowed in the vicinity of the beacon.

The sixth method compares images or parametric data derived from images taken by fixed or mobile systems with images or parametric data derived from images within an opt-out registry. If the image or parametric data can be correlated to images or parametric data of a person in the registry, the imagery and co-collected data (and perhaps correlated data) is erased or otherwise treated differently.

The seventh method compares personally identifiable data either co-collected with an image or subsequently correlated to an image to personally identifiable data in an opt-out registry. As with the previous method, if a match is found, the image and co-collected data (and perhaps the subsequently correlated data) is erased or otherwise treated differently.

The eighth method is similar to the seventh method but it is applied to previously collected or archived images and data. If matches are found with images or data in the opt-out registry, the images and co-collected data (and perhaps correlated data) is erased or otherwise flagged for different treatment.

The ninth method is a specific case of the third method wherein the individual, detectable signatures of a mobile device themselves are coded to indicate opt-out status for facial recognition. Unlike the simple beacon case in method three, the “beacon signal” in this case would contain personally identifiable information.

### BRIEF DESCRIPTION OF THE DRAWINGS

FIG. 1 shows an imaging device connected to a sensor where the sensor does not detect and signatures within range.

FIG. 2 shows an imaging device connected to a sensor where the sensor does detect a device signature within range and queries the opt-out registry to determine device opt out status.

FIG. 3 shows an imaging device connected to a sensor where the sensor does detect a signature within range but determines the direction of the signature is not within the imaging device field of view.

FIG. 4 shows an imaging device connected to a sensor where the sensor does detect a signature within range and further determines the direction of the signature is within the imaging device field of view; opt-out registry queried to determine device opt-out status.

FIG. 5 shows an imaging device connected to a sensor which detects an opt-out beacon within the field of view.

FIG. 6 shows a mobile imaging device with a locational sensor which can determine field of view; imaging permitted only if reference to opt-out registry determines that location permits intended imagery.

FIG. 7 shows a mobile imaging device detecting an opt-out beacon within its field of view precluding imaging.

FIG. 8 show a mobile imaging device detecting a device signature nearby. Image can be taken if device not within field of view or query to opt-out registry reveals device registered for opt-out.

FIG. 9 shows an imaging device (which could be fixed or mobile) which has imaged an individual. The image (or parametric data derived from the image) is compared to images in the opt-out registry; treatment of image and co-collected data is different match is found to opt-out registry image or image derived parametric data.

FIG. 10 shows an imaging device (which could be fixed or mobile) which has imaged an individual. Further processing of the image allows correlation of the image to other data. The correlated data is compared to the opt-out registry and the image and co-collected data (and perhaps correlated data) is treated differently if the correlated data identifies an individual in an opt-out registry.

FIG. 11 shows a database created in part from previously imaged individuals and which may include other data correlated to those individuals. A comparison is made to the image (or parametric data derived from the image) and correlated data to the opt-out registry and the image, co-collected data, and perhaps the correlated data is treated differently if the image (or parametric data derived from the image) or correlated data is found to match data in the opt-out registry. The image and co-collected data and perhaps the correlated data is treated differently if a match is found in the opt-out registry.

FIG. 12 shows an illustrative example whereby a mobile device user registers to opt-out of certain data collection and exploitation programs by making the signatures of the mobile device distinctive.

FIG. 13 shows how the signatures changed in FIG. 12 can be recognized and interpreted by an imaging or other sensor as to opt-out status of user.

### DETAILED DESCRIPTION OF THE PREFERRED EMBODIMENTS

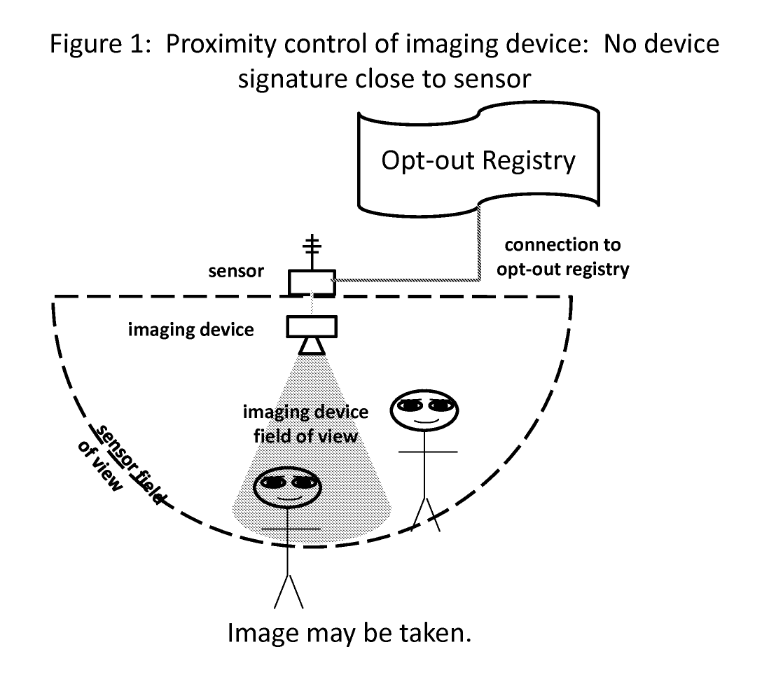

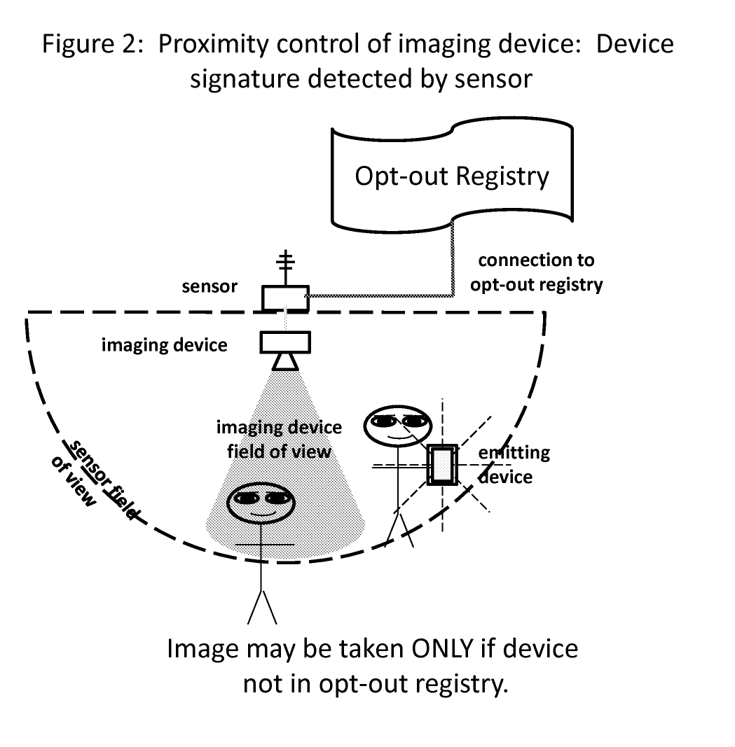

Developing opt-out processes for facial recognition is more complex than for other data collection in that some processing of an image or correlation of an image to other data is often needed before it can be determined whether or not the imaged individual is in an opted out status. The first process through which an opt-registry might function is through an individual registering a device with a personally identifiable phenomenon (or multiple phenomena) which a sensor attached to a still or video camera detects. The camera does not take images if the phenomenon (or multiple phenomena) is detected within a certain range. One example of an implementation of this method is a sensor which detects the MAC (Media Access Control) address of a cell phone or other mobile device.² FIG. 1 shows an example where no device is detected and imaging can proceed. FIG. 2 shows an example where a device is detected close to the imaging system. In this case, the imaging system would query the opt-out registry and only image if the device signature is not found within the registry. Note that this process could be inverted to only image those opted-in to a particular program or on a particular list (such as law enforcement looking to image a particular person). ² There are a number of other detectable signatures of cell phones or mobile devices and other detectable phenomena that could also be used.

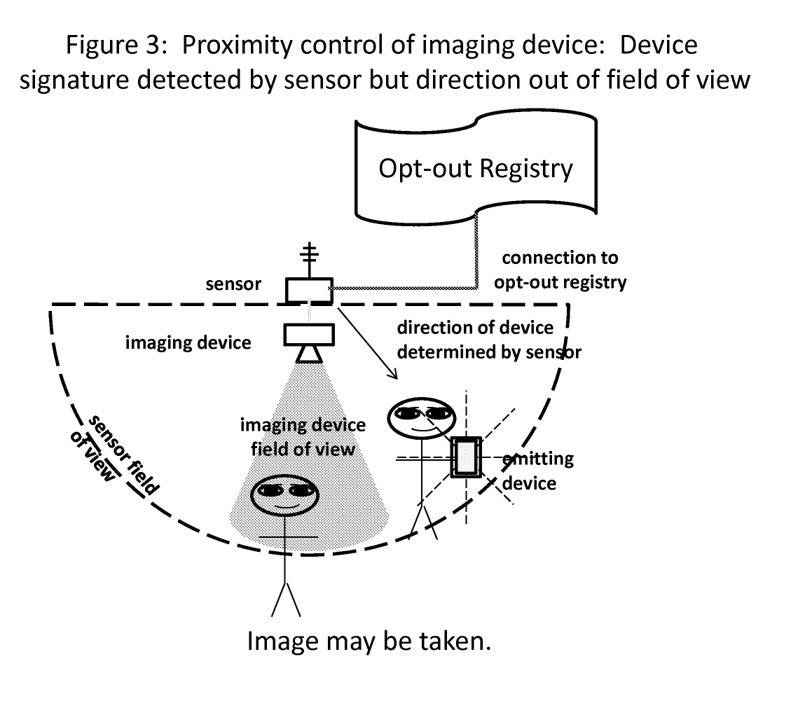

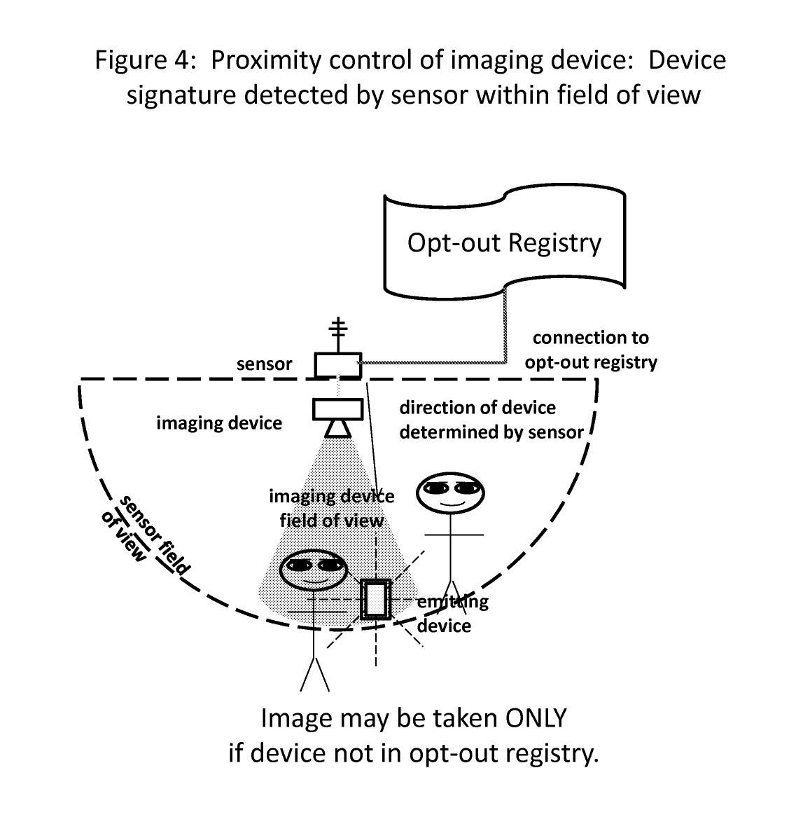

The second process is a refinement of the first process. A sensor attached to an imaging system can determine not only the proximity of a device but also the direction of the device allowing the sensor to determine through calculations whether the device (and an individual carrying it) is within the imaging system field of view. This can be done directly in systems with a fixed field of view or can be dynamically calculated when the field of view is variable (due to zoom in or out status of the imaging system or the direction in which an imaging system is pointing when it takes an image). FIG. 3 shows an instance where the sensor determines that no device is within the field of view (even though one is nearby). Imaging would be allowed. FIG. 4 shows an instance where a device (and an individual carrying it) is within the imaging device field of view. The imaging device queries the opt-out registry and image only if the device is not in the registry.

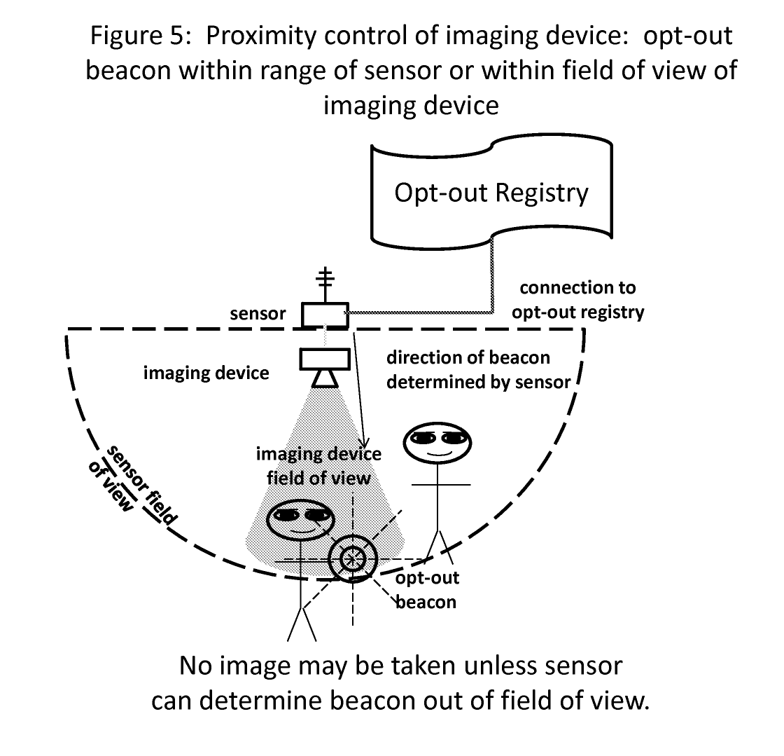

The third process uses an opt-out beacon. A device emits a signature which need not but might include personally identifiable information. The signature could be created by a specially designed device or could be created by another common device such as a smart phone. If an imaging system is near such a beacon, no images would be taken unless the imaging system can determine that the beacon (and an individual carrying it) is not within its field of view. FIG. 5 shows a case where a beacon is detected with the field of view of an imaging system precluding imaging.

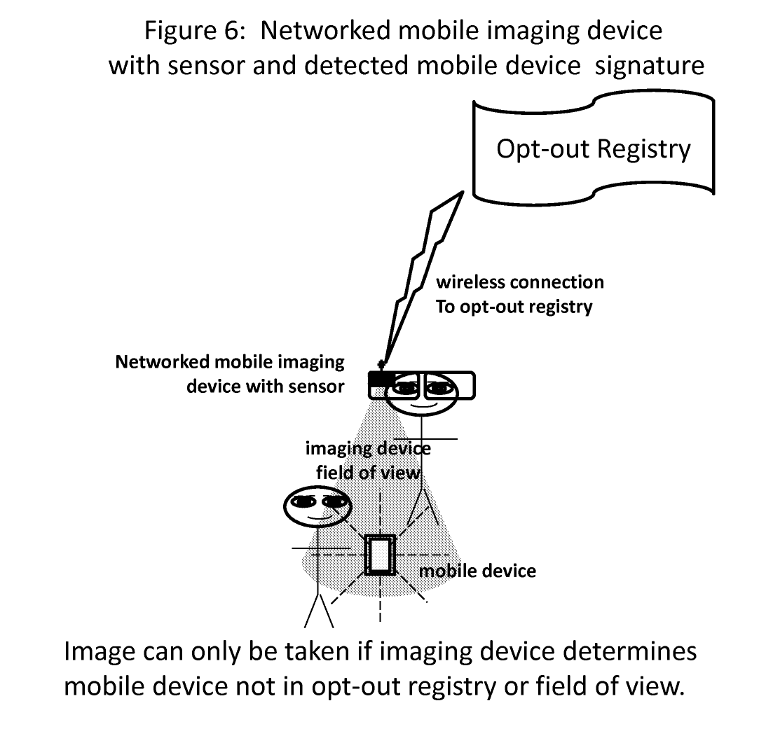

The first three processes (proximity to a device, device within field of view, and proximity (or within field of view) of an opt-out beacon) also can be used for networked mobile imaging devices (of which Google Glass® or the car Google uses to create street level imagery are examples). FIG. 6 shows a device within the field of view of a mobile imaging system. The opt-out registry would be consulted to determine whether imaging could proceed. If the device was instead an opt-out beacon, imagery would be precluded.

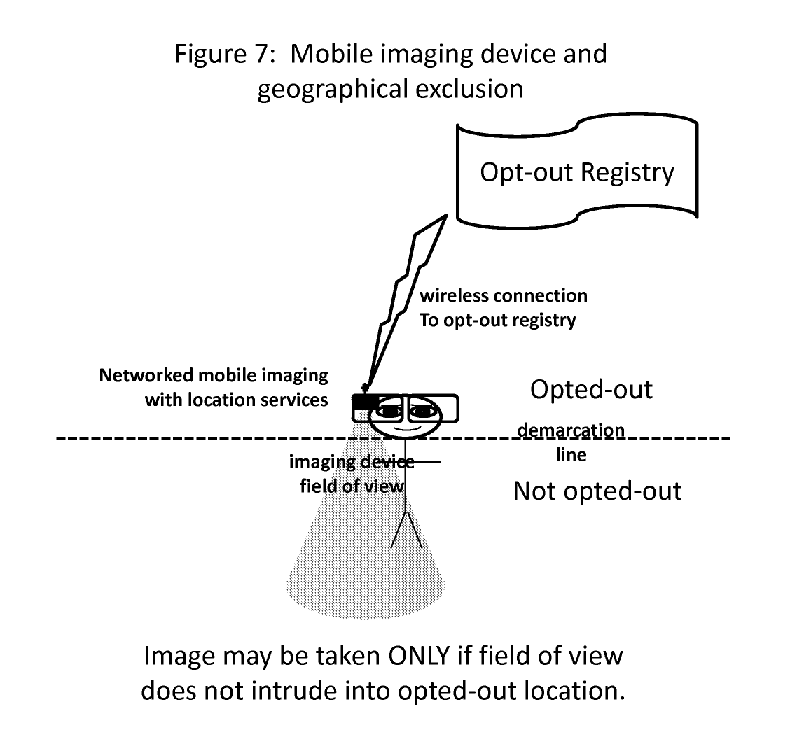

The fourth process relates to networked mobile imaging systems with locational capabilities (of which Google Glass® or the car Google uses to create street level imagery are examples). The mobile imaging system would query the opt-out database to determine if the imaging system is in or near a geographical area which is within the opt-out registry. If the device cannot ensure that its field of view does not extend into an opted-out area, no imagery would be allowed. FIG. 7 shows such an example.

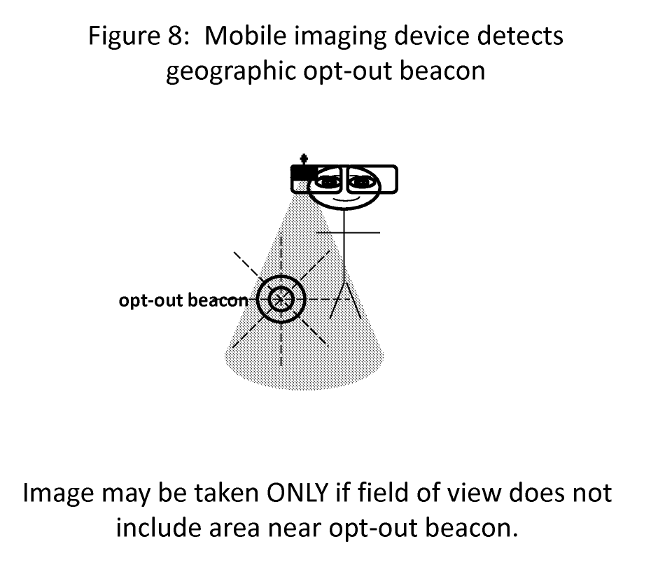

The fifth process relates to mobile imaging systems (of which Google Glass® or the car Google uses to create street level imagery are examples). A geographically fixed (or moveable)³ opt-out beacon is detected by the imaging system. The signal may or may not be the same signal from a personal opt-out beacon. The opt-out beacon may be a simple signal or more complex (for example, it might include information on what distance from the beacon is included in the opted-out area. This process could also be used for beyond facial recognition. For example, a movie theater could set up a beacon which would signal Google Glass® or other mobile imaging systems that video recording is not permitted while the beacon is on. FIG. 8 shows such a beacon detected within the field of view within a networked mobile imaging device. ³ A moveable beacon in this case is distinguished from a mobile beacon in that it remains in a fixed location while operating. For example, a touring band may wish to preclude imaging at its events and moves its beacon to each new event venue.

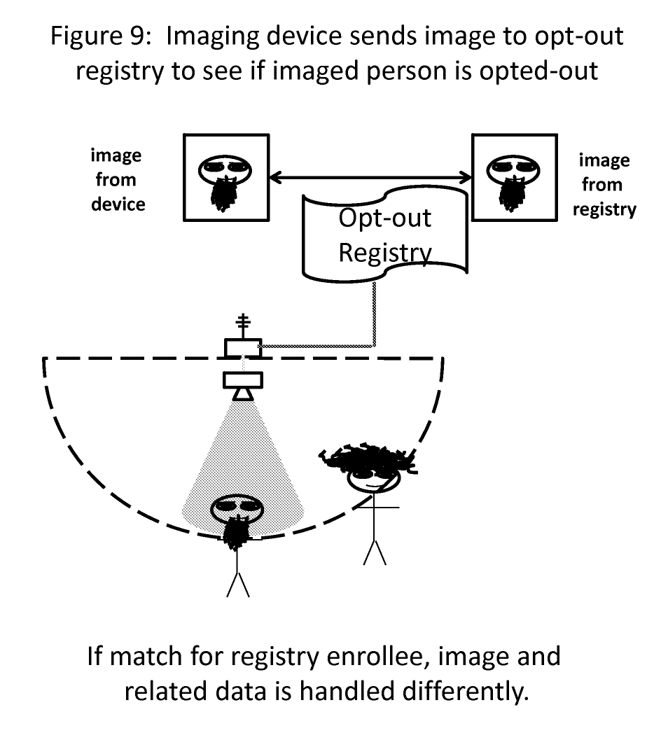

The sixth process related both to fixed and mobile imaging systems. An image has already been taken by such a system and co-collected data may be attached to the image (date, time, location, companions, etc.). That image is either compared to images within the opt-out registry or parametric information derived from image is compared to parametric data derived from images in the opt-out registry. If there is a match for the image, that image and co-collected data is treated differently. The alternative handling could be deletion, a halt to further processing or correlation to other information, or retention only for very circumscribed uses.⁴ FIG. 9 shows a comparison of images (or image derived parameters) to images (or image derived parameters) in an opt-out registry. ⁴ For example, a retail store may wish to exploit the images from its security cameras for marketing or wish to profit from the sale or exchange of data about who visits the store. Opted-out individuals might be removed from these programs while their images might be retained for the original purpose (a record of store activities to detect theft or vandalism).

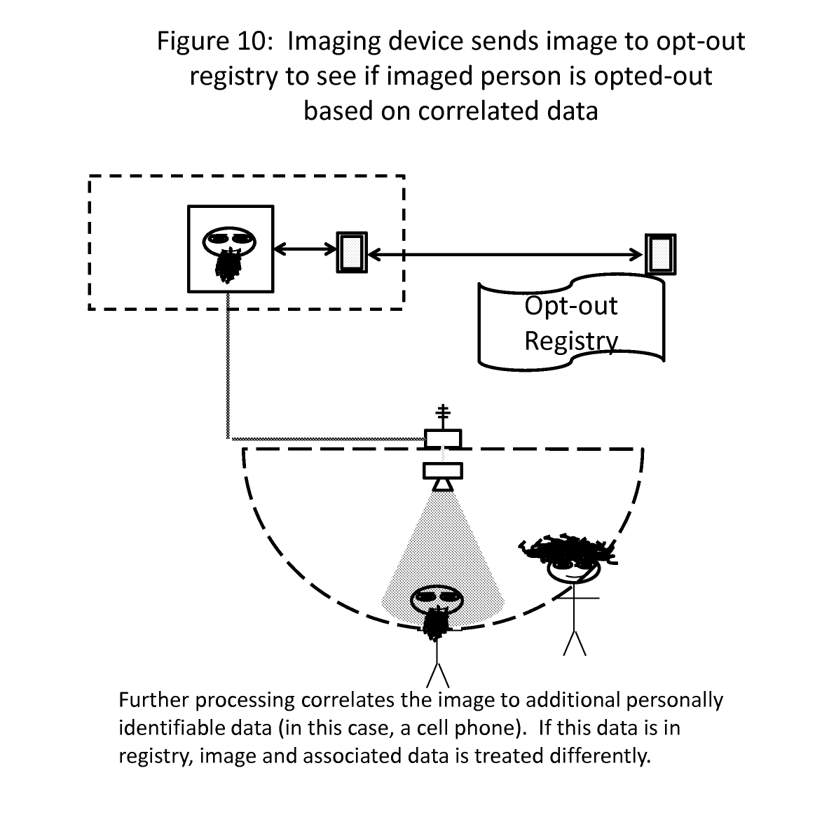

The seventh process also relates to images taken by fixed and mobile systems. Subsequent processing may correlate other data to an image. For example, the image may be correlated to a particular cell phone number. While the image may not be matched to an image in the opt-out registry, the correlated, personally identifiable data may be matched to corresponding data in the opt-out registry. If so, the image, co-collected data, and perhaps other correlated data would be treated differently. See FIG. 10.

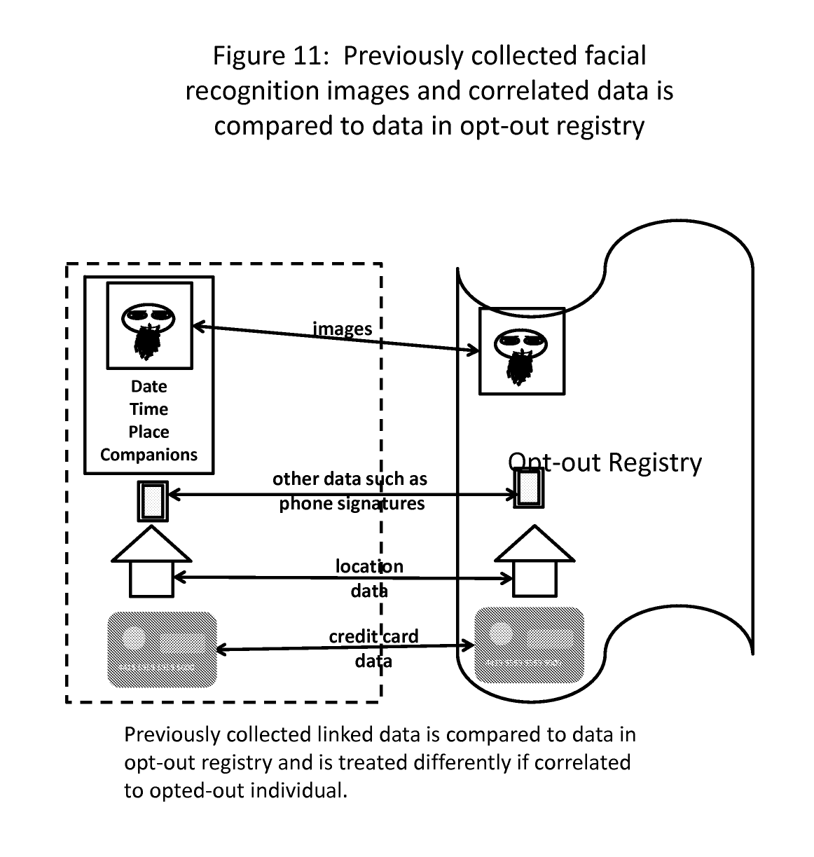

The eighth process is a variation of the seventh process. Existing databases of images, co-collected data, and correlated, personally identifiable data could be compared to corresponding data in an opt-out registry. If any match is found, the image, co-collected data, and perhaps other correlated data would be treated differently. FIG. 11 shows this process.

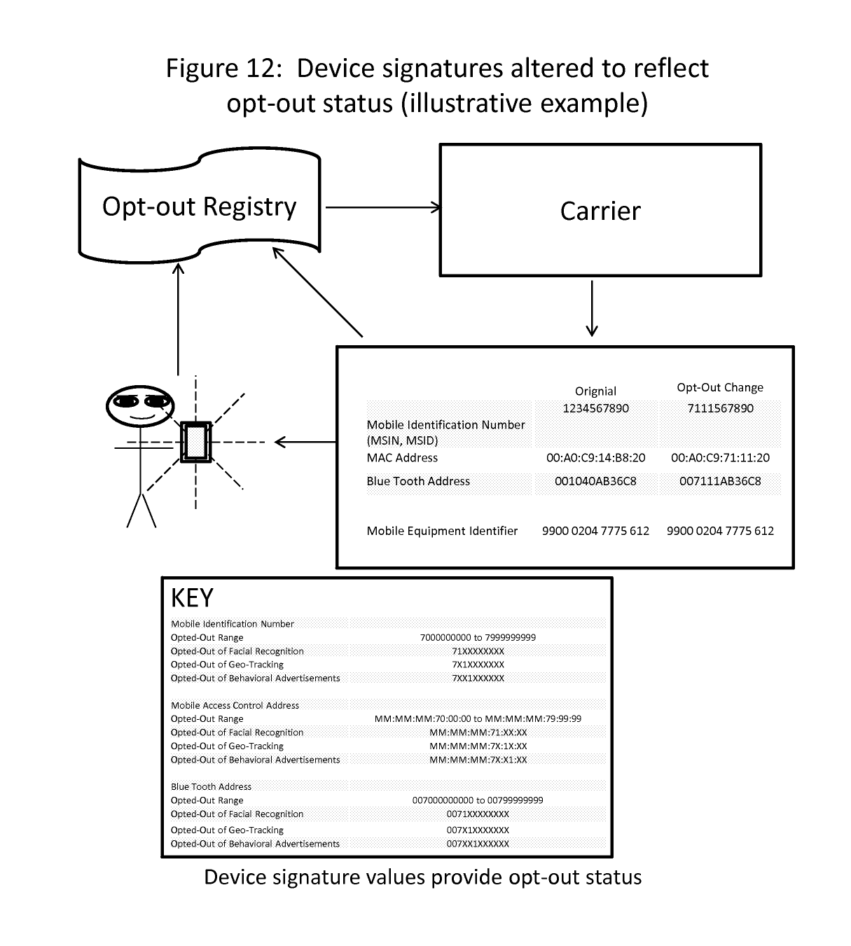

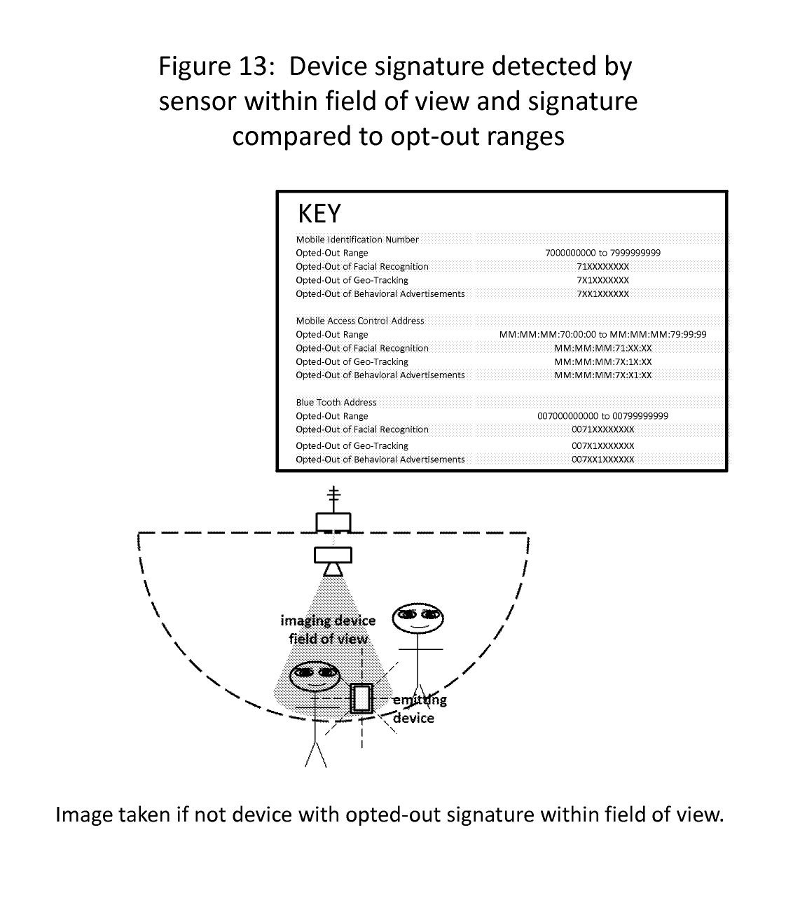

The ninth process is a variation of the first three processes. Signature emissions from a mobile device are organized so that certain ranges for these devices indicate the device user is opted-out of certain data collection and other practices including but not limited to facial recognition, geo-tracking, and behavioral advertising. In this case, the signature serves like a beacon. In the case of a beacon, no personally identifiable information need be included while the signature, in this process, includes the opt-out status and personally identifiable information. FIG. 12 shows an illustrative example wherein certain ranges for signatures indicate opt-out status. The use of ranges is just one way this process could be implemented. Odd or even numbers in certain fields, calculated values, etc., might be used. FIG. 13 shows a collection device (in this instance an imaging device) with an attached sensor which detects a signature (nearby or within field of view). The sensor consults the opt-out signature key to determine what collection, if any, is permitted.

What is claimed is:

1. A method whereby individuals enroll in a facial recognition opt-out registry which includes both preferences (or demands if legally supportable) about facial recognition and personally identifiable information which may include parametric (including biometric information) which might be matched to a collected facial image in order to express a preference for opting out of facial recognition or demand exclusion from the same.

2. A specific embodiment of claim 1 whereby parents or guardians enroll their children or wards in such a registry.

3. A specific embodiment of claim 1 whereby sensors linked to imaging systems, fixed or mobile, can detect personally identifiable phenomena of nearby individuals, query the opt-out registry, and image or refrain from imaging those individuals.

4. A specific embodiment of the claim 3 whereby a sensor, fixed or mobile, detects unique, personally identifiable signature from a cell phone or other mobile device and the imaging device images or refrains from imaging an individual when a the device signature (such as a MAC (media access code), address Bluetooth® address, or other signature used now or in the future and queries an opt-out registry to determine whether the person can be imaged or whether there are restrictions on the use of the image.

5. A further embodiments of claim 4 whereby a sensor detects and determines both proximity and direction of an identifiable signature and the imaging device paired with the sensor images or refrains from imaging an individual, based in inclusion or lack of inclusion in an opt-out registry, when that individual is in the field of view as determined by the proximity and direction of the device as determined by the sensor.

6. A method whereby a beacon alerts nearby imaging devices and other collection systems that the person carrying the beacon is opted-out of facial recognition, other collection activities, or other privacy intruding practices such as behavioral ad serving based on current location.

7. A variation of claim 6 whereby a mobile device broadcasts the beacon signal or transmits a signal in response to a query.

8. A specific method of claim 7 whereby an application or other software or firmware is placed on a device to create such a signature.

9. A specific embodiment of claim 6 whereby certain ranges or values for MAC addresses or Bluetooth® addresses or other signatures used now or in the future would denote the device is opted out of facial recognition or other collection or surveillance without necessarily requiring a query to an opt-out registry.

10. A specific embodiment of claim 7 wherein mobile device signatures as the MAC address of the Bluetooth® address or others used now or in the future can be changed on a device to denote that the user of the device is opted-out (or opted-in) to facial recognition collection, geo-tracking, or other data collection or surveillance means.

11. A specific embodiment of claim 6 wherein a fixed or mobile beacon alerts sensors that certain collection activities are not allowed in the area (the area rather than a person is opted out of the collection activities).

12. A method whereby data collected by an imaging system and related and connected sensors is compared to parametric and other data in an opt-out registry and if the collected data is correlated to the parametric data (i.e., a facial recognition match) or other data (such as unique mobile device identifiers), the collected data is treated differently (for example, it is deleted or its further processing, storage, or dissemination is restricted).

13. A method whereby a networked mobile device or mobile sensor of any sort with a locational sensor (such as GPS) queries an opt-out or opt-in registry to determine in certain types of data collection are permitted within that geographical area.

14. A specific embodiment of claim 13 whereby a networked mobile determines whether its collection range (i.e., field of view for an imaging system) includes an opted-out area (or is entirely within an opted-in area) through queries to an opt-out registry and the parameters of the collection system (i.e., direction, zoom, mode for an imaging system).
